(19) United States
(12) Patent Application Publication
(10) Pub. No.: US 2010/0100473 A1
(43) Pub. Date: Apr. 22, 2010

(54) Collar Indexes and Financial Products Based Thereon

(76) Inventor: Scott Nations, Chicago, IL (US)

Correspondence Address: Scott Nations, 1836 N. Maud, Chicago, IL, 60604, US

(21) Appl. No.: 12/580,341

(22) Filed: Oct. 16, 2009

Related U.S. Application Data
(60) Provisional application No. 61/196,273, filed on Oct. 16, 2008.

(51) Int. Cl. G06Q 40/00

(52) U.S. Cl. 705/37

(57) ABSTRACT

A financial instrument involves creating an underlying asset portfolio and implementing a passive total return “collar” strategy into the financial instrument based on writing a covered call option against that same underlying portfolio for a set period and using the premium from selling this new call option to buy protective put option diagonal spreads such that the long leg of the put option diagonal spread is longer-dated and struck closer to at-the-money than the short leg of the put option diagonal spread. All option positions are held until just prior to expiration of the shorter-dated options, at which time all option positions are closed, a new call option is sold, and the premium from that option is used buy new protective put option diagonal spreads.

### CROSS-REFERENCE TO RELATED APPLICATIONS

This application claims the benefit of priority from provisional patent application Ser. No. 61/196,273, filed on Oct. 16, 2008, entitled Enhanced Collar Indexes and Instruments Based Thereon. Application Ser. No. 61/196,273 is hereby incorporated by reference in its entirety.

### FIELD OF THE INVENTION

The present invention relates generally to a financial instrument and more particularly to a method of creating financial instruments and indexes involving option collars.

### BACKGROUND OF THE INVENTION

Hedging is often defined as the purchase or sale of a security or derivative, such as options or futures and the like, in order to reduce or neutralize all or some of the risk of holding another security or underlying asset. While there are several ways to hedge, one common method is to sell some or all of the potential appreciation in a portfolio in exchange for a cash payment and use this cash payment to purchase protective options. This ‘collar’ strategy is generally considered to be an investment strategy in which an investor owns a stock or index, sells call options that correspond to the stock or index and uses some or all of the proceeds from selling the call options to purchase protective put options.

An option is a contract between two parties in which one party has the right but not the obligation to do something, usually to buy or sell some underlying asset at a given price, called the exercise price or the strike price, on or before some given date. Call options give the option holder the right to buy the underlying asset, while put options give the holder the right to sell the underlying asset. In exchange for giving the holder this right the option seller receives cash, known as a premium. The writer of a call option must sell the underlying asset at the strike price if the option holder exercises his option prior to expiration while the put option writer must buy the underlying asset at the strike price if the put option holder exercises his option prior to expiration.

A ‘covered call’ option is a call option that is sold against the underlying security such as a stock, a bond, a basket of stocks, or another asset such as an exchange traded fund, a futures contract, a foreign currency or a physical commodity such as gold or silver.

A ‘protective put’ is a put option that is bought and for which the holder has paid a premium and which protects the underlying security such as a stock, a bond, a basket of stocks, or another asset such as an exchange traded fund, a futures contract, a foreign currency or a physical commodity such as gold or silver which the holder also owns.

A ‘collar’ is a combination of a covered call and a protective put. The term ‘collar’ refers to the range of potential profit and loss outcomes for the combined position of underlying, covered call and protective put. For example, assuming the premium received from selling the covered call precisely equals the cost of purchasing the protective put the maximum value of the combined position during the life of the options would be equal to the strike price of the call while the minimum value would be equal to the strike price of the put.

Diagonal option spreads are generally created when a writer buys one option and sells another wherein the two options are of the same type (call or put) but have different expiration dates and strike prices. Diagonal option spreads may be executed in order to take advantage of differences in the term structure of option prices with different expiration dates and/or to take advantage of different relative option prices, as evidenced by implied volatility and often called ‘skew’, for option strike prices different distances from at-the-money or to take advantage of both term structure and skew.

Vertical put debit spreads are spreads wherein a put option is purchased and another put option with the same expiration date but which is struck further out-of-the-money is sold. Vertical put debit spreads take advantage of put skew in that the relative price of the put option purchased, as measured by implied volatility, is usually less than that of the put option sold.

Existing and proposed option collar products such as described in United States Patent publication 2007/0016497 disclose holding a stock index portfolio, selling covered calls and purchasing protective puts such that the call options and put options are equidistant from at-the-money and have the same expiration date. Another collar strategy is the CBOE 95/110 Collar Index which discloses holding a stock index portfolio, selling covered calls with 30 days to expiration and with a strike price equal to 110% of the price of the underlying and buying longer dated protective puts with a strike price equal to 95% of the price of the underlying. While longer dated options are more expensive in absolute terms, they are generally less expensive in relative terms, as measured by implied volatility. This term structure is useful but the CBOE 95/110 Collar Index buys very expensive (in absolute terms) put options and sells very inexpensive covered calls and would be required to liquidate a portion of the underlying in most cycles to finance the difference between the premium received from the covered calls and that paid for the protective puts.

One drawback of these existing collar strategies is that the premium required to purchase the protective puts is greater than that received from selling covered calls. For example, a put option that is 5% out of the money is likely to be more expensive than a call option that is 5% out of the money. This is generally due to the demand for put options as insurance. Thus, in the traditional collar strategy, a portion of the underlying asset must be liquidated in order to cover the shortfall. In those strategies which adjust the respective strike prices so that the net premium is zero, the strike price of the put is generally further from at-the-money than the strike price of the call. Thus, the percentage move that results in the index ceasing to participate in the appreciation of the underlying index is smaller than the percentage move that results in the index being protected from a decline in the underlying index. In addition, as the put option purchased gets further from at-the-money skew increases such that put options further from at-the-money are more expensive on a relative basis, as measured by implied volatility, than put options nearer to at-the-money.

Another drawback of collars wherein all expiration dates are equal is that they don't take advantage of the term structure of option prices nor do they take advantage of the lower daily price erosion of longer-dated options. Generally, longer dated options trade at a lower relative price, as measured by implied volatility, than shorter-dated options and collar methodologies that use options with a single maturity do not take advantage of this phenomenon. Also, the expected daily price erosion of options increases exponentially as the time to expiration decreases. Collar strategies that use a single expiration for all options do not take advantage of this phenomenon.

Another drawback of traditional collar strategies is that they protect from the underlying asset falling to zero, an extreme event, which in the index world has never occurred and the protection for this extreme event is very expensive.

Thus, what is needed is a financial instrument that uses the premium generated from selling covered calls to provide significant protection while taking advantage of the term structure of options as well as skew.

### SUMMARY

A financial instrument in accordance with the principles of the present invention is created wherein a securities portfolio is purchased, covered call options are written against that portfolio, the cash received in the form of call option premium is then used to purchase protective put option diagonal spreads. For each option cycle, the portfolio manager simultaneously writes call options just above the portfolio forward price and purchases protective put option diagonal spreads, such that the premium received from selling the covered calls equals the net premium paid for the protective put option diagonal spread. When the near-term options are near expiry all the options are closed out while simultaneously selling new covered calls and purchasing new put option diagonal spreads such that the premium received from selling covered calls equal that paid for the protective put option diagonal spreads.

In particular, the method of creating a financial instrument includes creating an underlying asset portfolio, writing short-dated covered call options against the underlying asset portfolio, purchasing protective put option diagonal spreads composed of purchasing a longer-dated put with a strike price closer to at-the-money and selling a shorter-dated put with a strike price further from at-the-money such that the total premium received from selling the covered calls is equal to that paid for the protective put option diagonal spreads. When the shorter-dated options are near expiration all the option positions are closed and new options with new expiration dates and strike prices are executed such that the premium received from selling covered calls equal that paid for the protective put option diagonal spreads.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a block diagram view of a specific embodiment of a computer system on which the financial instrument may be implemented in accordance with the present invention;

FIG. 2 represents a single chart of a specific embodiment showing the properties of the realized returns of the example index, the underlying index (in this case the S&P 500) and the collar benchmark.

### DETAILED DESCRIPTION

In accordance with the principles of the present invention, a series of financial instruments is created by investing in a portfolio of stocks, writing a short-dated, just out-of-the-money call option against the underlying asset portfolio and using the premium received from selling call options to buy protective put option diagonal spreads such that the put option purchased is both longer-dated and struck closer to at-the-money than the put option sold. Existing option positions are closed simultaneously with the execution of new option positions in a process called ‘rolling’ the options. The roll may be executed at the close of trading on the day prior to maturity of the short-dated options. Maturity is generally the third Friday of each calendar month and is determined in advance of option listing by the relevant exchange. In the preferred embodiment the long leg of the protective put option diagonal spreads may have a strike price immediately below the price of the asset portfolio and a strike price of the put option sold a fixed percentage of the price of the underlying below that of the put option purchased.

In accordance with one embodiment of the present invention, existing option positions may be held until the shorter-dated options expire and cash settle, at which time a new nearby, just out-of-the-money call and new protective put option diagonal spreads are executed.

In another embodiment, an instrument was designed to reflect a portfolio that invests in Standard & Poors® 500 index stocks that also sells S&P 500® index covered call options and uses the premium received to purchase S&P 500® protective put diagonal spreads (ticker symbol “SPX”). The S&P 500® is disseminated by Standard & Poor's, 55 Water Street, New York, N.Y. 10041 (“S&P”). S&P 500® index options are offered by the Chicago Board Options Exchange®, 400 S. LaSalle Street, Chicago, Ill. 60605 (“CBOE”). In an alternative embodiment, an index may be designed to reflect a portfolio that invests in Dow Jones Industrials Average Index stocks that also sells Dow Jones Industrials Average Index covered call options and purchases Dow Jones Industrials Average Index protective put option diagonal spreads (ticker symbol “DJX”). The Dow Jones Industrials Average index is disseminated by Dow Jones & Company, Dow Jones Indexes, P.O. Box 300, Princeton, N.J. 08543-0300. Dow Jones Industrials Average index options are offered by the Chicago Board Options Exchange (CBOE).

### Example 1

### Nations Large Cap Enhanced Collar Index^{SM}

In another embodiment in accordance with the present invention, an instrument may be designed, referred to as Nations Large Cap Enhanced Collar Index^{SM}, which measures the total rate of return of a hypothetical “enhanced collar” strategy applied to the S&P 500 Index. This strategy consists of a portfolio consisting of a long position indexed to the S&P 500 Index on which are sold a succession of one-month covered call options and on which are purchased a succession of protective put option diagonal spreads on the S&P Index such that the put option purchased has approximately 2 months to expiration while the put option sold has approximately 1 month to expiration. Options on the S&P Index are listed on the Chicago Board Options Exchange (CBOE) under the ticker symbol “SPX”. The protective put option diagonal spread has a width between strikes that is a fixed percentage of the value of the underlying and the number of protective put option diagonal spreads is such that all the premium received from selling covered calls is used to purchase protective put option diagonal spreads, even in those instances when the notional value of the resulting protective put option diagonal spreads is greater than that of the underlying. This portfolio is referred to as the “Nations Large Cap Enhanced Collar Portfolio^{SM}”.

The S&P forward price is calculated by compounding the underlying portfolio by the S&P 500 dividend yield for the life of the short-dated SPX options. The formula for determining the Forward Price for the next nearby option expiration (assuming the next nearby option expires in one month) is:

Forward Price=S&P 500 Index*(1+(S&P Index Annual Dividend Yield/12))

The following example uses actual prices from the Dec. 20, 2007 roll. Prior to the close, the level of the S&P 500 Index was 1460.12 and the S&P 500 annual dividend yield was 1.83%. The Forward Price would be:

1462.35=1460.12*(1+(0.0183/12))

The nearby call option with a strike price immediately above this forward price is the call option that will be deemed sold. If the Forward Price is precisely equal to a strike price, then that is the strike price of the covered call. If the Forward Price is precisely equidistant from two strike prices, the strike price closer to at-the-money is used. Generally, SPX option strike prices are listed in 5 point increments. In this example, the strike price for the covered call would be 1465 and the expiration date would be Jan. 18, 2008.

In the example, the put option with a strike price immediately below this forward price and with approximately 60 days to expiration is the put option that will be deemed purchased while the put option deemed sold to complete the protective put option diagonal spread is the put option with approximately 30 days to expiration and with a strike price closest to 5% below that of the put option purchased. If 5% below the strike price of the put option purchased is equidistant from two strike prices the strike price closest to at-the-money is used. In the current example, given the Forward Price of 1462.35 and the call strike price of 1465, the strike price of the put option bought would be 1460 and the expiration date would be Feb. 15, 2008. The strike price of the put option sold to complete the protective put option diagonal spread would be calculated by:

Strike Price of the Put Option Purchased*0.95

In the current example, this would be:

1387.00=1460*0.95

The strike price closest to 1387.00 is 1385. This is the strike price of the put option to be deemed sold while the expiration would be Jan. 18, 2008. Now that the relevant options have been identified, the next calculation determines the number of protective put option diagonal spreads deemed purchased (Diagonal Percentage). For this index example, the number of protective put option diagonal spreads deemed purchased is a fraction. That number is calculated by:

Price of the Call Option/(Price of the Put Option Deemed Purchased−Price of the Put Option Deemed Sold)

In the current example, the Diagonal Percentage would be:

0.89522=30.00/(44.00−10.50)

The Nations Large Cap Enhanced Collar Index is a chained index, i.e., its value is equal to 1000 times the cumulative product of gross daily rates of return of the Nations Large Cap Enhanced Collar portfolio since the inception date of the Index.

On any given day, the Index is calculated as follows:

Index_{T}=Index_{T-1}*(1+R_{T})

where R_{T} is the daily rate of return of the Index portfolio. This rate includes ordinary cash dividends paid on the stocks in the underlying the S&P 500 Index that trade “ex-dividend” on that date.

On each trading day, the daily gross rate of return of the Index equals the change in the value of the components of the Index portfolio, including the value of ordinary cash dividends payable on component stocks underlying the S&P 500 Index that trade “ex-dividend” on that date, as measured from the close in trading on the preceding trading day. The gross daily rate of return is equal to:

1+R_{T}=(S&P_{T}+Div_{T}−Call_{T}+((Long Put_{T}−Short Put_{T})*Diagonal Percentage_{T}))/(S&P_{T-1}−Call_{T-1}+((Long Put_{T-1}−Short Put_{T-1})*Diagonal Percentage_{T-1})

In this equation, S&P_{T} is the closing value of the S&P 500 Index at date T, Div_{T} represents the ordinary cash dividends payable on the component stocks underlying the S&P 500 Index that trade “ex-dividend” at date T expressed in S&P 500 Index points, Call_{T} is the last price of the call option at date T, Long Put_{T} is the last price of the long leg of the diagonal spread on date T, Short Put_{T} is the last price of the short leg of the diagonal spread on date T and Diagonal Percentage_{T} is the Diagonal Percentage calculated on the preceding roll date. S&P_{T-1} is the closing value of the S&P 500 Index on the preceding trading day, Call_{T-1} is the last price of the call option on the preceding trading day, Long Put_{T-1} is the last price of the long leg of the diagonal spread on the preceding trading day, Short Put_{T-1} is the last price of the short leg of the diagonal spread on the preceding trading day.

As an example, on Dec. 21, 2007 the Nations Large Cap Enhanced Collar Index was calculated as:

1+R_{T}=(1484.46+0.2276−43.50+((32.00−5.30)*0.89552)/(1460.12−30.00+((44.00−10.50)*0.89552)

Thus 1+R_{T}=1.00341

Since the Nations Large Cap Enhanced Collar Index was 2287.48 at the close on Dec. 20, 2007, it would have been 2295.28 (2287.48*1.00341) at the close on Dec. 21, 2007.

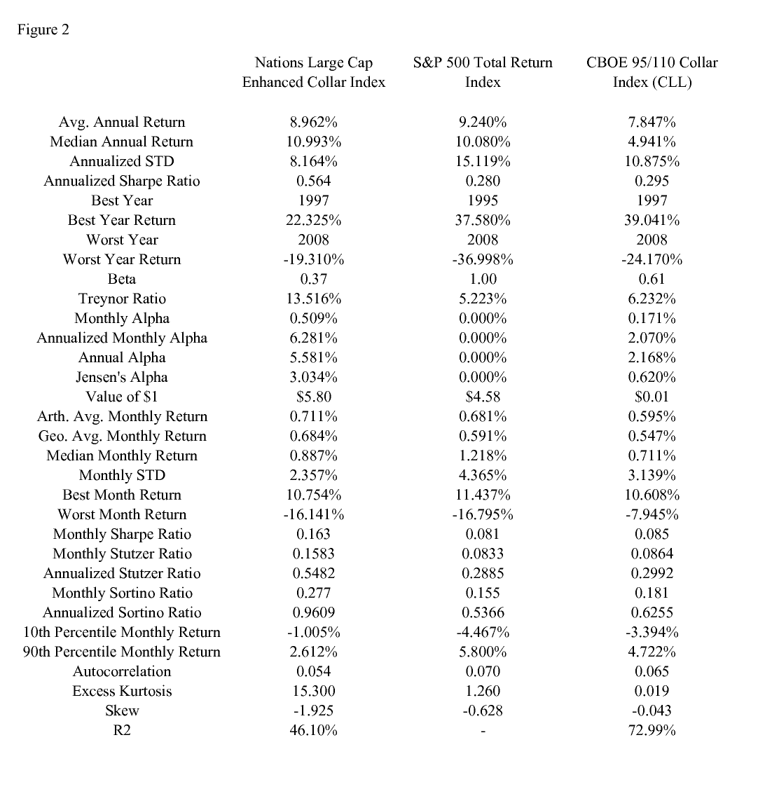

FIG. 2 lists the properties of the realized monthly returns of the example index for January 1990 to September 2009 inclusive, in accordance with the principles of the present invention where Nations Large Cap Enhanced Collar Index^{SM} represents the example index. The properties of monthly returns for the S&P 500 Total Return Index and the collar benchmark are also listed.

FIG. 2 shows that the average monthly return of the S&P 500 Total Return Index (SPTR) for the January 1990 to September 2009 period was 0.681%, while the example index generated an average monthly return of 0.711% and the collar benchmark generated an average annual return of 0.595%. For the example index, the standard deviation of monthly returns was 2.357%, while, for the SPTR, the standard deviation was 4.365%. The monthly standard deviation of the collar benchmark was 3.139%. The example index generated monthly returns much greater than the benchmark while assuming less risk. This is illustrated by the monthly Sharpe Ratios contained in FIG. 2. The monthly Sharpe Ratio for the example index was 0.163, while for the SPTR the monthly Sharpe Ratio was 0.081 and for the benchmark it was 0.085. The Sharpe Ratio measures the amount of return generated for each unit of risk assumed so a higher Sharpe Ratio is superior to a lower Sharpe Ratio. The Sharpe Ratio is calculated as:

Sharpe Ratio=(Period Return−Period Risk Free Rate of Return)/Standard Deviation of Period Returns

### Advantages of the Present Invention

In addition to expressing an enhanced collar strategy that generates superior return, lower risk and superior risk-adjusted return than both the underlying index and the benchmark collar index, the present invention also takes advantage of option skew. Skew is the phenomenon whereby put options become relatively more expensive, as measured by implied volatility, as the distance of the strike price from at-the-money increases. The present invention also takes advantage of the term structure of options whereby the longer dated options tend to be relatively less expensive, as measured by implied volatility, than shorter dated options. The present invention also takes advantage of both skew and term structure simultaneously.

The present invention sometimes provides protection of more than 100% of the underlying for the width of the diagonal spread. This occurs when more diagonal spreads are deemed bought than covered calls are deemed sold. In these cases the present invention would not simply stop losses until the underlying market reached the strike price of the short put, the resulting financial vehicles would actually increase in value as the underlying market fell until it fell past the strike price of the short put. It's also important to recognize that the short put in the present invention is considered ‘covered’ per the SEC by the long put.

Another advantage of the present invention is that the put sold pays for part of the long put. In fact, the short put pays for a disproportionate share of the long put since the implied volatility of the short put is generally greater than that of the long put due to skew.

Another advantage of the present invention is that the number of protective put option diagonal spreads is modulated and correlates to the VIX such that more protective put option diagonal spreads are purchased when the VIX, and hence implied volatility is high. For the period January 1990 to September 2009, the R squared of the diagonal percentage and the VIX is 39.15%.

Another advantage of the present invention is that it tends to buy puts that are cheaper as measured by implied volatility than the calls sold and sells downside puts that are more expensive as measured by implied volatility than the puts purchased and are usually some of the most expensive options listed on the underlying.

Another advantage of the present invention is that the expected daily price erosion for the longer dated put option is usually lower than for a put with the same strike price but less time to expiration and the expected daily price erosion for the longer dated put is usually lower than for the short call. This daily price erosion, called theta, increases exponentially as the time to expiration nears.

Another advantage of the present invention of existing collar strategies is that since the put option purchased is at-the-money, the protection against falling underlying prices begins almost immediately.

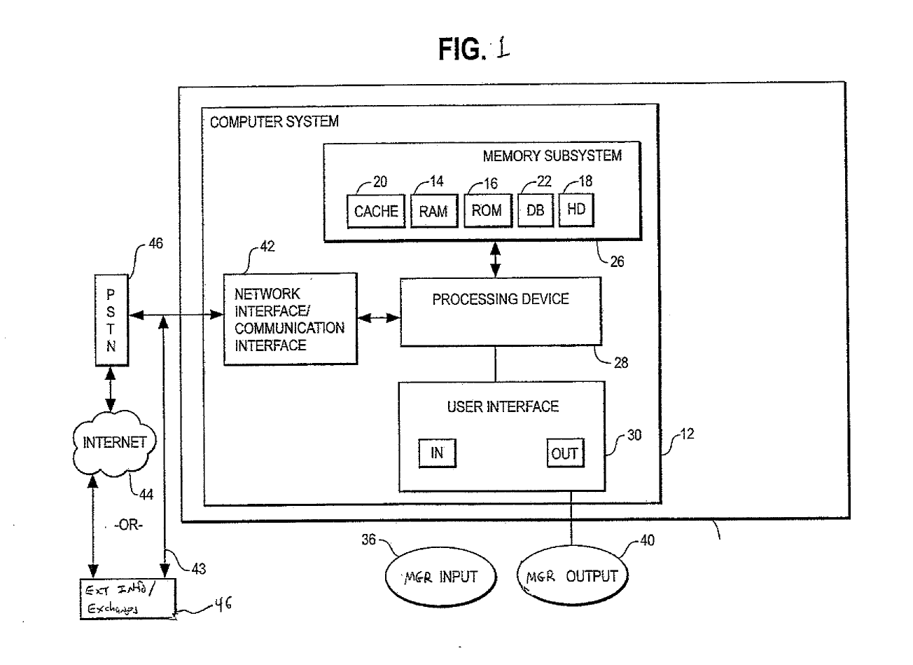

The present invention as described above may be embodied as a system cooperating with computer hardware components, and as a computer-implemented method. Referring now to FIG. 1, a specific embodiment of a high-level hardware block diagram of a computer system on which the above-described financial instrument may be implemented is shown generally. A computer system 10 includes a computer or processing system 12, which includes various hardware components, such as RAM 14, ROM 16, hard disk storage 18, cache memory 20, database storage 22, and the like (also referred to as “memory subsystem” 26), as is known in the art. The computer system 12 may include any suitable processing device 28, such as a computer, microprocessor, RISC processor (reduced instruction set computer), CISC processor (complex instruction set computer), mainframe computer, work station, single-chip computer, distributed processor, server, controller, micro-controller, discrete logic computer and the like, as is known in the art. For example, the processing device 28 may be an Intel Pentium® microprocessor, x86 compatible microprocessor, or equivalent device.

The memory subsystem 26 may include any suitable storage components, such as RAM, EPROM (electrically programmable ROM), flash memory, dynamic memory, static memory, FIFO (first-in first-out) memory, LIFO (last-in first-out) memory, circular memory, semiconductor memory, bubble memory, buffer memory, disk memory, optical memory, cache memory, and the like. Any suitable form of memory may be used whether fixed storage on a magnetic medium, storage in a semiconductor device or remote storage accessible through a communication link.

A user or system manager interface 30 may be coupled to the computer system 12 and may include various input devices 36, such as switches selectable by the system manager and/or a keyboard. The user interface also may include suitable output devices 40, such as an LCD display, a CRT, various LED indicators and/or a speech output device, as is known in the art. To communicate between the computer system 12 and external sources, a communication interface 42 may be operatively coupled to the computer system. The communication interface 42 may be, for example, a local area network, as an Ethernet network, intranet, Internet or other suitable network 43. The communication interface 42 may also be connected to a public switched telephone network (PSTN) 46 or POTS (plain old telephone system), which may facilitate communication via the Internet 44. Dedicated and remote networks may also be employed and the system may further communicate with external exchanges and sources of information 46. Any suitable commercially available communication device or network may be used, as is known in the art. However, the present methodology may be implemented in a computer system or may be performed by human steps using appropriate communication mediums.

Specific embodiments of a collar indexes and financial products thereon according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. A method of creating a financial instrument comprising:
creating an underlying asset portfolio;
writing a covered call option against the underlying asset portfolio;
buying protective put option diagonal spreads wherein the put option purchased is longer-dated and struck nearer at-the-money than the put option sold and such that a premium received from selling the initial call option equals the cost of the protective put option diagonal spreads;
holding the entire portfolio until the options are closed out;
writing a new covered call option against the underlying asset portfolio; and
buying new protective put option diagonal spreads wherein the put option purchased is both longer-dated and struck nearer at-the-money than the put option sold and such that the premium received from selling the new call option equals the cost of the new protective put option diagonal spreads

2. The method of making a financial instrument of claim 1 wherein the options are cash-settled.

3. The method of making a financial instrument of claim 1 wherein the options are held until expiration.

4. The method of making a financial instrument of claim 1 wherein the options are closed out prior to expiration.

5. The method of making a financial instrument of claim 1 wherein the call option comprises a basket of call options.

6. The method of making a financial instrument of claim 1 wherein the call option is a call option credit spread.

7. The method of making a financial instrument of claim 1 wherein the call option is a basket of call option credit spreads.

8. The method of making a financial instrument of claim 1 wherein the put option diagonal spreads are a basket of put option diagonal spreads.

9. The method of making a financial instrument of claim 1 wherein the notional value of the protective put option diagonal spreads is greater than that of the underlying asset

10. The method of making a financial instrument of claim 1 wherein the put option diagonal spreads are of fixed width between strike prices.

11. The method of making a financial instrument of claim 1 wherein the put option diagonal spreads are of a width between strike prices that is a fixed percentage of the value of the underlying asset.

12. The method of making a financial instrument of claim 1 wherein the put option diagonal spreads are of variable width between strike prices.

13. The method of making a financial instrument of claim 1 wherein the difference in time to expiration between the options comprising the put option diagonal spread is fixed.

14. The method of making a financial instrument of claim 1 wherein the difference in time to expiration between the options comprising the put option diagonal spread is variable.

15. The method of making a financial instrument of claim 1 wherein the options comprise security options.

16. The method of making a financial instrument of claim 16 wherein the options comprise stock options.

17. The method of making a financial instrument of claim 1 wherein the options comprise commodity options.

18. The method of making a financial instrument of claim 1 wherein the options comprise stock index options.

19. The method of making a financial instrument of claim 19 wherein the stock index options are the STANDARD & POOR′S 500 INDEX.

20. The method of making a financial instrument of claim 1 wherein the underlying asset comprises a stock.

21. The method of making a financial instrument of claim 1 wherein the underlying asset comprises a basket of stocks.

22. The method of making a financial instrument of claim 1 wherein an underlying asset comprises an exchange-traded fund.

23. The method of making a financial instrument of claim 1 wherein the underlying asset comprises an exchange-traded future.

24. The method of making a financial instrument of claim 1 wherein the underlying asset portfolio is selected from the group comprising a security, a derivative and a commodity.

25. The method of making a financial instrument of claim 1 wherein the financial instrument is an exchange traded fund.

26. The method of making a financial instrument of claim 1 wherein a strike price of the covered call is just above a prevailing underlying asset portfolio price level.

27. The method of making a financial instrument of claim 1 wherein a strike price of the covered call is just above a compounded price level of the underlying asset portfolio.

28. The method of making a financial instrument of claim 1 wherein a strike price of the put option purchased is just below the strike price of the call option sold.

29. The method of making a financial instrument of claim 7 wherein the initial call option credit spreads have a fixed width.

30. The method of making a financial instrument of claim 7 wherein the initial call option credit spreads have a variable width.

31. A method of managing a financial instrument comprising:
providing an underlying asset portfolio;
writing a covered call option against the underlying asset portfolio;
purchasing protective put option diagonal spreads such that the long leg of the spread is struck just below the strike price of the covered call and has a greater time to expiration than the short leg which is struck further from at-the-money than the put option purchased and such that the premium received from selling the covered call is equal to the net premium paid for the protective put option diagonal spreads;
holding the portfolio until the options are closed out;
writing a new covered call option against the underlying asset portfolio; and
purchasing new protective put option diagonal spreads such that the long leg of the spread is struck just below the strike price of the covered call and has a greater time to expiration than the short leg which is struck further from at-the-money than the put option purchased and such that the premium received from selling the new covered call is equal to the net premium paid for the new protective put option diagonal spreads.

34. A computer-based method of managing a financial instrument comprising:
providing a computer system;
providing an underlying asset portfolio;
writing a covered call option against the underlying asset portfolio;
purchasing protective put option diagonal spreads such that the long leg of the spread is struck just below the strike price of the covered call and has a greater time to expiration than the short leg which is struck further from at-the-money than the put option purchased and such that the premium received from selling the covered call is equal to the net premium paid for the protective put option diagonal spreads;
holding the portfolio until the options are closed out;
writing a new covered call option against the underlying asset portfolio; and
purchasing new protective put option diagonal spreads such that the long leg of the spread is struck just below the strike price of the covered call and has a greater time to expiration than the short leg which is struck further from at-the-money than the put option purchased and such that the premium received from selling the new covered call is equal to the net premium paid for the new protective put option diagonal spreads.

35. The method of making a financial instrument of claim 1 wherein the premium paid for the protective put option diagonal spreads is less than the total premium received from selling the covered call.

36. The method of making a financial instrument of claim 1 wherein the premium paid for the protective put option diagonal spreads is greater than the total premium received from selling the covered call.

37. A method of creating a financial instrument comprising:
creating an underlying asset portfolio;
writing a covered call option against the underlying asset portfolio;
buying protective put option vertical spreads wherein the put option purchased has an expiration date that is identical to the put option sold but such that the put option purchased has a strike price that is nearer to at-the-money than the put option sold and such that a premium received from selling the initial call option equals the cost of the protective put option vertical spreads;
holding the entire portfolio until the options are closed out;
writing a new covered call option against the underlying asset portfolio; and
buying new protective put option vertical spreads wherein the put option purchased has an expiration date that is identical to the put option sold but such that the put option purchased has a strike price that is nearer to at-the-money than the put option sold and such that a premium received from selling the initial call option equals the cost of the protective put option vertical spreads.
